(19) United States
(12) Patent Application Publication
(10) Pub. No.: US 2006/0203775 A1
(43) Pub. Date: Sep. 14, 2006

(54) Method and apparatus for optimizing label switched paths (LSPs) setup in a packet data network

(76) Inventor: Yves Lemieux, Kirkland (CA)

Correspondence Address: ALEX NICOLAESCU;Ericsson Canada Inc., Patent Department, 8400 Decarie Blvd., Town Mount Royal, QC, H4P 2N2, CA

(21) Appl. No.: 11/239,213

(22) Filed: Sep. 30, 2005

Related U.S. Application Data
(60) Provisional application No. 60/659,411, filed on Mar. 9, 2005.

(51) Int. Cl. H04Q 7/00; H04Q 7/20

(52) U.S. Cl. 370/331; 455/436

(57) ABSTRACT

A method and a Core Network Gateway node for performing a handoff operation for a Mobile Terminal (MT) that receives and sends encapsulated packet data in a packet data network. The Core network Gateway comprises a service logic for receiving at the Core Network Gateway node a Routing Area (RA) request message from the MT, which indicates that the MT is handing off in the packet data network. The Core network Gateway nodes further comprises a duplicator/combiner for duplicating encapsulated packet data sent from a Corresponding node to the MT and for combining Label Switched Path (LSPs) in the packet data network. The Core Network Gateway node also comprises a switching element for switching the encapsulated packet data from a LSP to another LSP when the MT hands off in the packet data network.

### PRIORITY STATEMENT UNDER 35 U.S.C S.119(e) & 37 C.F.R. S.1.78

This non-provisional patent application claims priority based upon the prior U.S. provisional patent application entitled “GTP-evolved in a context of VPN and mobility-IP”, application No. 60/659,411, filed Mar. 9, 2005, in the name of Yves Lemieux.

### BACKGROUND OF THE INVENTION

1. Field of the invention

The invention relates to a method and apparatus for providing IP mobility to a Mobile Terminal (MT) in a packet data network.

2. Description of the Related Art

The third generation (3G) Universal Mobile Telecommunications Systems (UMTS) for mobile communication, targets the convergence of telephony, based on an Internet Protocol (IP) network, and also a suite of new services in order to generate new opportunities. For example, the IMS (Internet Multimedia Sub-System) definition under third partnership project (3GPP) confirms this trend.

Reference is now made to FIG. 1, which describes an example of a packet data network 10 that is based on a Multi-Label Switched Path (MPLS) architecture. MPLS may support Large scale Mobile-IP. For example, LDP (Label Distribution Protocol) may be used for establishing LSP (Label Switched Path) between a mobile agent such as between a Home Agent (HA) 16 a Gateway Foreign Agent (GFA) 18 and ultimately to a roaming Mobile Terminal (MT) 12.

In the network 10 a Mobile Terminal (MT) 12 receives services such as voice and data from a Corresponding node (CN) 13. The MT 12 may roam and handoff between from the HA 16 to the FA 18. The MT 12 may also handoff from a first Regional Foreign Agent (RFA) 20 to a second RFA 20 or from a first Local FA 22 to second Local FA 22.

The MPLS backbone network can build the large-scale Mobile IP network. A Mobile IP network is connected to other Mobile IP network via a Label Edge Router (LER) 14. In order to support Mobile IP services, the MPLS network have to accommodate HA 16 and GFA 18. The LER 14 is capable of forwarding Mobile IP packets by encapsulating with relevant label header. The LER 14 can be a FA or its corresponding node. In order to support mobility, the LER 14 acts as a gateway router for the network 10. To support the hierarchical architecture, the GFA 18 or RFA 20 could be defined in the network 10. As for the control procedure, the label distribution protocol (LDP) may be extended to set up the Label switched path (LSP) tunnel between the mobile agents (that is, foreign agents and home agents) through the network 10. The IP-in-IP tunnels of Mobile IP Network can be provided by the one or multiple LSPs through the MPLS network. When a mobile node is moving to the foreign area, the existing LSPs may be extended without service interrupt. The short-cut LSPs between source and destination mobile nodes may be recalculated to avoid the long cascaded connections.

Although the existing UMTS technology is adequate for the traffic types of the 2G and 2.5G, a General Packet Radio Service (GPRS) Tunneling Protocol (GTP) sub-part may be used to support handoff of the MT 12 with a sustained Quality-of-Service (QoS) which has been originally derived from a GPRS architecture. GTP is defined in as defined in 3GPP TS 29.060 entitled “3rd Generation Partnership Project (3GPP) Technical Specification Group Core Network; General Packet Radio Service (GPRS); GPRS Tunnelling Protocol (GTP) across the Gn and Gp Interfaces”.

In theory, the GTP protocol provides a means for establishing tunnels in the network 10. GPRS is a technology used in UMTS to provide connectivity, mobility and resource management. The GTP protocol consists of two parts, the Control part or GTP-C and the User part or GTP-U. GTP establishes tunnels to transport packets coming from overlay protocols such as IP, primitive frames etc., in order to forward it adequately with respect to the mobility required.

In the signaling plane, GTP-C specifies the control of tunnels and the management protocol to allow RFA such as a Serving GPRS Support Nodes (SGSNs) to offer GPRS services such as Web Browsing, Short Message Service (SMS), Multimedia Messaging Service (MMS) to the MT 12. In particular, GTP-C provides a mechanism for to creating, modifying and tearing down GPRS data packet tunnels. In general, GTP operates on the layer 4 of the User Datagram Protocol (UDP) protocol as defined in 3GPP TS 29.060 entitled “3rd Generation Partnership Project (3GPP) Technical Specification Group Core Network; General Packet Radio Service (GPRS); GPRS Tunnelling Protocol (GTP) across the Gn and Gp Interfaces” and runs over Internet Protocol (IP) for the purpose of networking. The GTP-U sub-part uses the tunnels established by GTP-C to convey the User data packets.

However, the integration of GTP in a UMTS network does not fulfill completely the needs of services such as Web-Applications that are provided to the MT 12. This is due to the fact that it already depends on IP as lower layer, while GTP itself encapsulates IP packets from higher layers. Therefore, there are some delays and packet data loss for the sending of encapsulated packet data on LSPs when a MT hands off for example from a HA16 to a GFA18. Therefore, it is necessary to eliminate packet data loss and to improve the routing of encapsulated packet data on LSPs in a packet data network. The invention provides a solution to this problem.

### SUMMARY OF THE INVENTION

It is a broad object of the present invention to provide a method for performing a handoff operation for a Mobile Terminal (MT), wherein the MT is connected to a Core Network Gateway node through at least one assigned Label Switching Path (LSP) in a first service area of a packet data network, the method comprising the steps of:

receiving at the Core Network Gateway node a Routing Area (RA) request message from the MT, the RA request message indicating that the MT is handing off from a first Access server to in the first service area to a second Access server in a second service area of the packet data network;

combining at the Core Network Gateway node, the encapsulated packet data are sent from the MT a Corresponding node on the at least one assigned LSP in the first service area and at least one assigned LSP in the second service area;

sending the combined encapsulated packet data from the Core Network Gateway node to the Corresponding node; and

switching at the Core Network Gateway node the encapsulated packet data from the at least one assigned LSP in the first service area to at least one assigned LSP in the second service area.

It is another broad object of the present invention to provide a method for performing a handoff operation for a Mobile Terminal (MT), wherein the MT is connected to a Core Network Gateway node through at least one assigned Label Switching Path (LSP) in a first service area of a packet data network, the method comprising the steps of:

receiving at the Core Network Gateway node a routing area (RA) request from the MT, the RA request indicating that the MT is handing off from a first Access server to in the first service area to a second Access server in a second service area of the packet data network;

duplicating at the Core Network Gateway node the encapsulated packet data sent from a Corresponding node to the MT;

switching the encapsulated packet data from the at least one assigned LSP in the first service area to at least one assigned LSP in the second service area; and

sending from the Core Network Gateway node to the MT, the duplicated encapsulated packet data, the packet data are sent on the at least one assigned LSP in the second service area.

It is another broad object of the present invention to provide a Core Network Gateway node for routing encapsulated packet data to a MT during a handoff operation, the Core Network Gateway node comprising:

a service logic for receiving at the Core Network Gateway node a Routing Area (RA) request from the MT, the RA request indicating that the MT is handing off from a first service area to a second service area of a Core Network, detecting at the Core Network Gateway node that the traffic direction of encapsulated packet data sent on the at least one assigned LSP in the first service area, sending from the Core Network Gateway node to the MT the duplicated packet data the packet data are sent on the at least one assigned LSP in the second service area, sending the combined encapsulated packet data from the Core Network Gateway node to a Corresponding node;

a duplicator for duplicating at the Core Network Gateway node the encapsulated packet data sent from a Corresponding node to the MT;

a combiner for combining at the Gateway node, the at least one assigned LSP in the first service area and at least one assigned LSP in the first service area; and

a switching element for switching the encapsulated packet data from the at least one assigned LSP in the first service for at least one assigned LSP in the second service area.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 depicts a packet data network based on MPLS in accordance to the prior art;

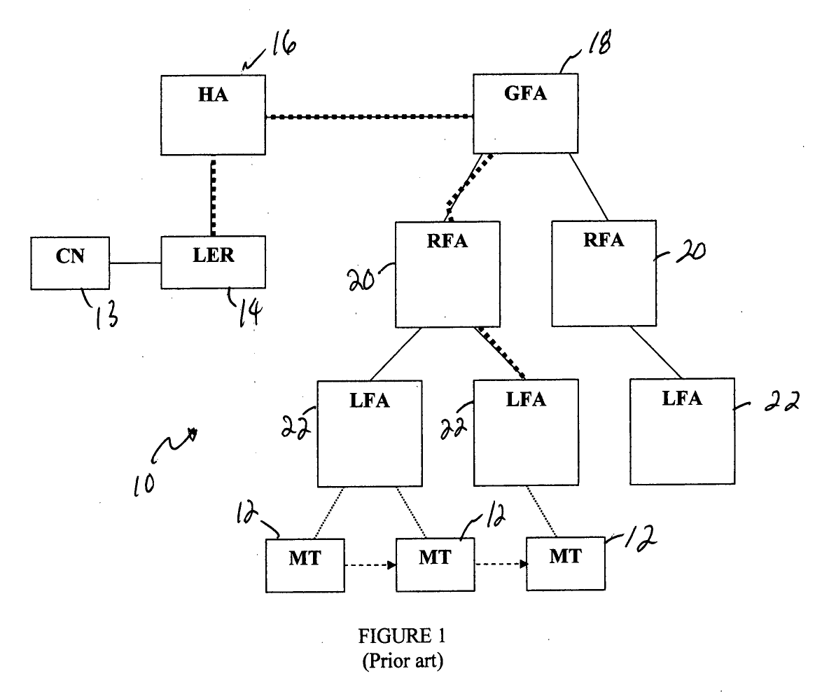

FIG. 2 a schematic diagram illustrating a packet data network for providing packet data services to a roaming MT in accordance to the invention;

FIG. 3A is a flow chart describing steps a method for performing a handoff operation for the MT 112 with minimal interruption of packet data flow in accordance to the invention;

FIG. 3B is a flow chart describing steps a method for performing a handoff operation for the MT 112 with minimal interruption of packet data flow when the traffic of encapsulated packet data is sent from the MT to a Corresponding node in accordance to the invention; and

FIG. 3C is a flow chart describing steps a method for performing a handoff operation for the MT 112 with minimal interruption of packet data flow when the traffic of encapsulated packet data is sent from a Core Network Gateway node to the MT in accordance to the invention.

### DETAILED DESCRIPTION OF THE PREFERRED EMBODIMENTS

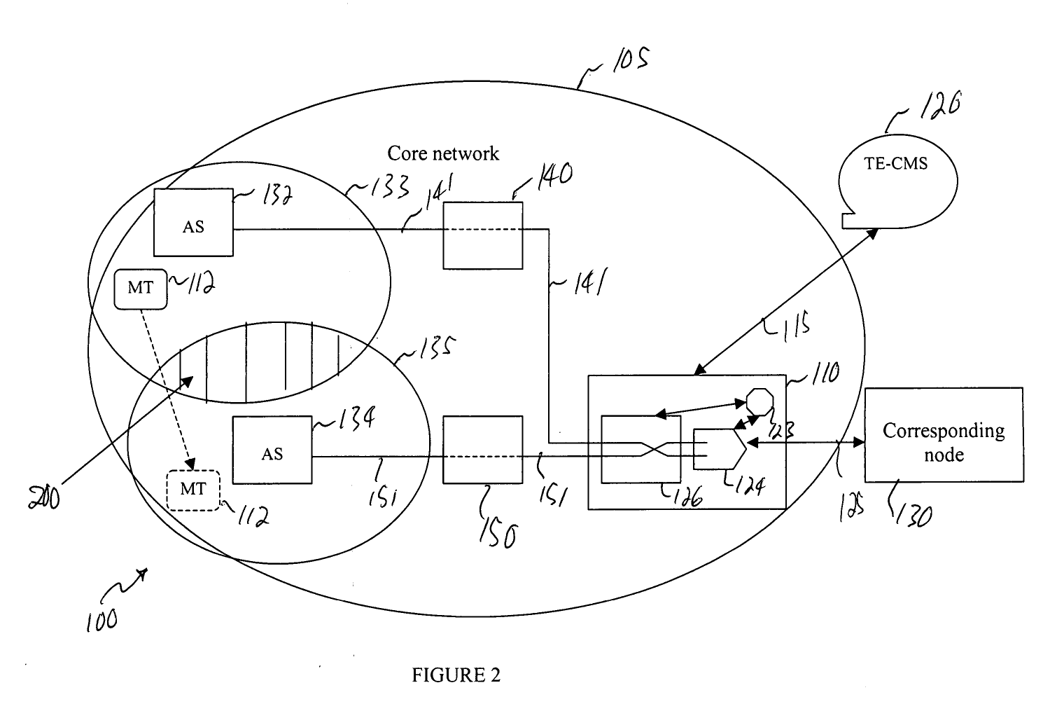

Reference is now made concurrently to FIG. 2, which is a schematic diagram illustrating a packet data network 100 for providing packet data services to a roaming Mobile Terminal (MT) 12 in accordance to the invention. The packet data network 100 is may be based on a MPLS architecture such as the MPLS network 10 described in the prior art. The packet data network 100 may be improved with a Mobile Internet Protocol Version 6 (MIPv6) architecture MIPv6 architecture. The MIPv6 (is defined in Request for Comments (RFC) 3775 Mobility Support in IPv6, Internet Engineering Task Force (IETF), June 2004. The utilization of MIPv6which eliminates the need of a Foreign Agent (FA). The packet data network 100 comprises a Core network 105.

The Core network 105 comprises at least one Core Network Gateway node 110 for routing encapsulated packet data to a Mobile Terminal (MT) 112. The MT 112 can be any mobile equipment of a subscriber that is registered in the packet data network 100.

The packet data network 100 also comprises Access servers 132 and 134 for providing packet data services such as Internet Protocol (IP) services such as Voice over IP (VoIP) and more generally voice/data multimedia and Web based applications to the MT 112 in the packet data network 100. The MT 112 may roam in the packet data network 100 and also receive packet data services from different locations namely service areas. The Access servers 132 and 134 provide packet data services to the MT 112 in services areas 133 and 135 respectively. The Access servers 132 and 134 are responsible for delivering of data packets from and to MTs within service areas 133 and 135 respectively. The Access servers 132 and 134 handle the data traffic from and to MTs in a geographical service area. The Access servers 132 and 134 interact with a Gateway node 110 for allowing IP network access to MTs.

The Access servers 132 and 134 are further linked to Transiting nodes 140 and 150 respectively. The Transiting nodes 140 and 150 act as routers between Access servers 132 and 134 and a Core network Gateway node 110 in the Core network 105. Using such architecture allow decreasing a possibility of packet data loss during transmission of packet data from or to the MT 112.

The packet data network 100 is preferably described as a generalized packet data network in the present invention. The packet data network 100 may be any 2G network such as in a Time Division Multiple Access (TDMA) network or a Code Division Multiple Access (CDMA), 2.5G networks such as a General Packet Radio Service (GPRS) any 3G Universal Mobile Telecommunications Systems (3G UMTS) network such as a CDMA2000 network a Wideband Code Division Multiple Access (WCDMA) network, a Global System for Mobile Communications/Enhanced Data for GSM Evolution (GSM/EDGE) or a High Speed Packet Data Access, (HSPDA) network. For example,a Core Network Gateway node may-be a Gateway GPRS Service Node (GGSN) and an Access server may be a Serving GPRS Service Node (SGSN) in a GPRS network. More particularly in 3G networks, the Core Network Gateway node 110 and the Access servers 132 and 134 may be combined as a Packet Data Service Node (PDSN).

The Core Network Gateway node 110 supports routing functions in the packet data network 100 and acts as an Internet Protocol (IP) router. The Core Network Gateway node 110 also applies firewall and filtering functionality for protecting the integrity of the packet data network 110 and provides billing information and sends access-requests for MTs to an Authentication, Authorization, and Accounting (AAA) node (not shown).

The Core Network Gateway node 110 comprises a service logic 123 for receiving and sending messages in the packet data network 100 and ultimately for operating the Core Network Gateway node 110. The service logic 123 is connected to a combiner/duplicator unit 124. The combiner/duplicator unit 124 allows the Core Network Gateway node to combine and duplicate packet data sent on a Label Switching Path (LSP). A LSP is assigned in order to receive and send from and to a corresponding node 130 in the packet data network 100 to and from the MT 112. The combiner/duplicator unit 124 and the service logic 123 are connected to a switching element 126. The switching element 126 allows the Core Network Gateway node 110 to switch a traffic of encapsulated from a first assigned LSP in a first service area to a second assigned LSP in a second service area when the MT 112 roams and consequently handoffs to the second service area. The service logic 123, the combiner/duplicator unit 124 and the switching element 126 can also be used as distinct network elements instead of being collocated in the Core Network Gateway node 110. Furthermore, each one of the service logic 123, the combiner/duplicator unit 124 and the switching element 126 can be a software, a hardware, processors or any combination thereof. Furthermore, the functions, responsibilities and steps performed at the service logic 123, the combiner/duplicator-unit 124 and the switching element 126 may be-alternatively be transferred one to another without departing from the spirit of the invention

The GPRS Tunneling Protocol (GTP) as defined in as defined in 3GPP TS 29.060 entitled “3rd Generation Partnership Project (3GPP) Technical Specification Group Core Network; General Packet Radio Service (GPRS); GPRS Tunnelling Protocol (GTP) across the Gn and Gp Interfaces” can be used in the packet data network 100 for LSP tunneling. In particular, any similar tunneling protocol can be applied for tunneling encapsulated packet data in the packet data network 100. In order to optimize the LSP setup without packet data loss, the invention provides an evolution path for GTP, based on MPLS. The present invention provides a method for establishment of tunnels and promotes the use of a plurality of pre-defined LSPs, to be used when needed especially when inter-Access server handoff are triggered in the Core network 105.

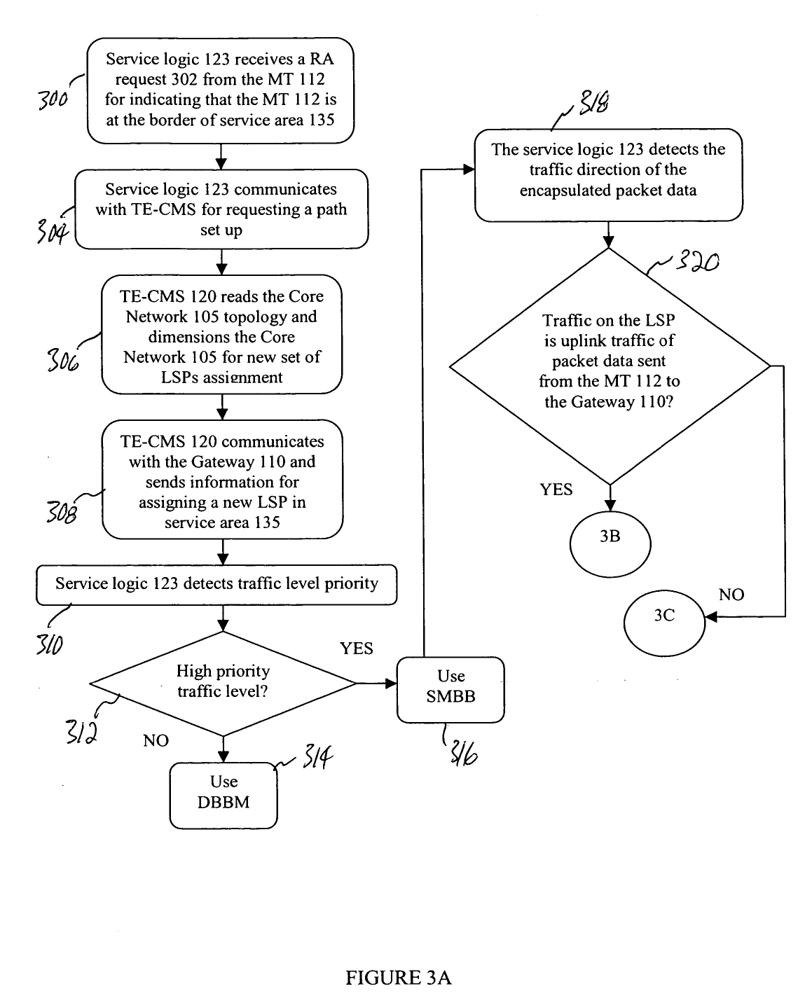

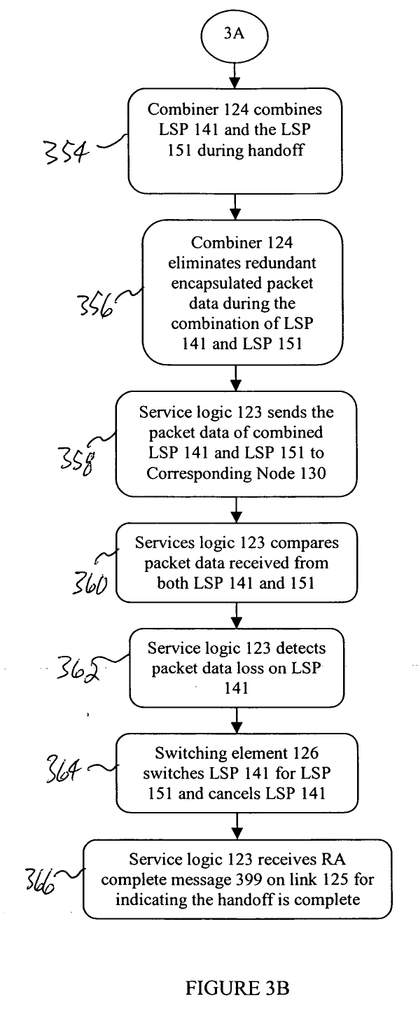

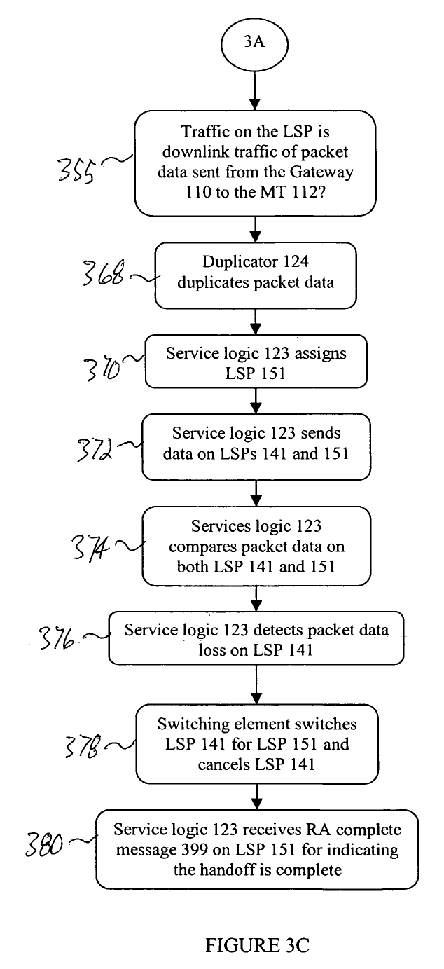

Reference is now made to FIG. 3A, which is a flow chart describing steps a method for performing a handoff operation for the MT 112 with minimal interruption of packet data flow from the Access server 132 in the service area 133 to the Access 134 in the service area 135. In FIG. 3A, the MT 112 is roaming from the service area 133 to the service area 135 and is still connected to the Gateway through LSP 141.

In order to indicate that the MT 112 is the in an intermediate region 200 between the service area 133 and the service area 135 and therefore handing off to the Access server 134, the MT 112 sends a Routing Area (RA) request message 302 (step 300). Upon reception of the RA request message 302 at the Gateway 110, the service logic 123 communicates with a Traffic Engineering-Configuration Management System (TE-CMS) entity 120 for requesting a path set up for a new LSP in the service area 135 (step 304). The TE-CMS 120 is responsible for reading the Core network topology and based on this it calculates the LSP paths to be assigned to the MT 112. The reading and calculations are be performed prior or in parallel to the reception of the request form the service logic 123. The TE-CMS 120 communicates with the Gateway node 110 and sends information for assigning a new path (LSP 151) in the service area 135 (step 308). Subsequently or in parallel to the calculations at the TE-CMS 120, the service logic 123 detects the traffic level priority (step 310). The service logic 123 internally determines the priority based on the encapsulated packet data transmitted on the LSP 141 (step 312). If the traffic priority level is not a high priority traffic level, the service logic performs Dynamic Break-before-Make (DBBM) mode of operation (step 314).

However, if the traffic priority level is a high priority traffic level, the service logic 123 performs a Static Make-before-Break (SMBB) mode of operation (step 316). Following this, at step 318, the service logic 123 detects the traffic direction of encapsulated packet data sent on the assigned LSP 141 in the service area 133.

If the traffic of encapsulated packet data are sent from the MT 112 to the Gateway node 110 and ultimately to the Corresponding node 130, the method of FIG. 3B applies. Reference is now made to FIG. 3B, which is a flow chart describing steps of a method for performing a handoff operation with minimal interruption of packet data flow for the MT 112 when the traffic of encapsulated packet data are sent from the MT 112 to the Gateway node 110 and ultimately to the Corresponding node 130. At step 354, the combiner/duplicator 124 combines the assigned LSP 141 and the assigned LSP 151 during the handoff operation. The service logic 123 further sends the combined encapsulated packet data from the Gateway node 110 to the Corresponding node 130 on path 125 (step 358) and eliminates redundant encapsulated packet data received at the Gateway node 110, from assigned LSP 141 and the assigned LSP 151. The Corresponding node 130 may be, while not being limited to, another MT such as MT 112, a VoIP server or a Public Switched Telephone Network (PSTN) phone. At step 360, the service logic 123 compares the encapsulated packet data received on the assigned LSP 141 and the assigned LSP 151 and detects a packet data loss of encapsulated packet data on the LSP 141 (step 362). The switching element 126 further switches the LSP 141 for the assigned LSP 151. The MT 112 is not in the intermediate region 200 anymore. When the handoff operation is complete the MT 112 sends a RA complete message to the Gateway node 110.

Alternatively, if the traffic direction of encapsulated packet data is from the Gateway node 110 to the MT 112 the method of FIG. 3C applies. Reference is now made to FIG. 3C, which is a flow chart describing steps of a method for performing a handoff operation with minimal interruption of packet data flow for the MT 112 when the traffic of encapsulated packet data are sent from the Gateway node 110 to the MT 112. At step 368, the duplicator/combiner 124 duplicates the encapsulated packet data sent from the Corresponding node 130 to the MT 112. At step 370, the service logic 123, based on this determination, assigns LSP 151 for the MT 112 in the service area 135. Next, the service logic 123 sends data on both LSPs 141 and 151 (step 372) and compares encapsulated data send on both LSP (step 374). When the MT 112 leaves the intermediate region 200 and is located only in service area 135, the Gateway node 110 detects a packet data loss and that MT 112 has handed off to the Access server 134 (step 376). As a consequence at step 378, the switching element 126 switches the LSP 141 for the LSP 151 and cancels LSP 141. When the handoff operation is complete the MT 112 sends a RA complete message 399 to the Gateway node 110 (step 380).

The combiner/duplicator 124 provides a switching time, which is close to null, since the two paths are available before the LSP switching takes place. In the case of the DBBM mode of operation, the pre-defined LSPs are turned into dynamic LSPs and do not require the combiner/duplicator 124 to be inserted at the Gateway node 110. Just before the break, a backup path is established within a time of about I msec and the LSPs are switched. It is recommended to use the DBBM mode of operation for handoffs that require a great number of LSPs, such as in the case of voice channels aggregations for to preserve scalability in the packet data network 100. On the other hand, the SMBB method can be used for the highly mission critical traffic such as 911 emergency calls.

Therefore is possible to switch between LSP within a time setup such as less than 25 milliseconds or 1 millisecond in a DBBM mode of operation, and close to 0.0 second because an assigned LSP for a MT is combined before it is switched in a SMBB mode of operation. DBBM may be used for a handoff that requires large scalability such as for VoIP and the SBBM mode of operation for high priority traffic level such as 911 calls.

The invention provides an evolution path for GTP, in order to allow a Wireless all-IP Network Access to MTs and to be more efficient during LSP establishment in a packet data network based on MPLS such as the packet data 100. This would therefore alleviate time delays such as 2-10 seconds for setting up LSPs experienced by the GTP protocol and this mainly during inter-Access server handoff operations.

It can be understood that some messages and therefore some parameters sent from the MT I 12 to the packet data network 100 and vice versa are not mentioned nor described for clarity reasons. Also some messages and therefore some parameters sent between network elements in the packet data network 100 are omitted for clarity reasons. More particularly, it should also be understood that FIG. 2 to FIG. 3C depict a simplified packet data network 100, and that many other network elements have been omitted for clarity reasons only. Furthermore, FIG. 2 to FIG. 3C refer only to the assignment and the switching of one LSP. For example in FIG. 2, there is only one LSP assigned to the MT when it is located in service area 133 and another LSP. It can be understood that more than one LSP 141 can be assigned to the MT I 12. For example the MT 112 may receive more than one packet data service or more than one LSP can be assigned for the same packet data service.

Although several preferred embodiments of the method and the Core Network Gateway node of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for performing a handoff operation for a Mobile Terminal (MT), wherein the MT is connected to a Core Network Gateway node through at least one assigned Label Switching Path (LSP) in a first service area of a packet data network, the method comprising the steps of:
receiving at the Core Network Gateway node a Routing Area (RA) request message from the MT, the RA request message indicating that the MT is handing off from a first Access server in the first service area to a second Access server in a second service area of the packet data network;
assigning at the Core Network Gateway node at least one LSP for the MT in the second area:
combining at the Core Network Gateway node, the encapsulated packet data that are sent from the MT to a Corresponding node on the at least one assigned LSP for the MT in the first service area and the encapsulated packet data that are sent from the MT to the Corresponding node on at least one assigned LSP for the in the second service area; and
sending the combined encapsulated packet data from the Core Network Gateway node to the Corresponding node.

2. The method of claim 1, wherein step of sending a path setup request from the Core Network Gateway node to a TE-CMS for assigning the at least one LSP for the MT in the second service area is executed prior the step of assigning at the Core Network Gateway node the at least one LSP for the MT in the second service area.

3. The method of claim 1, wherein the step of combining includes a step of eliminating redundant encapsulated packet data received at the Core Network Gateway node on the at least one assigned LSP in the first service area and on the at least one assigned LSP in the second service area.

4. The method of claim 1, wherein the step of sending at the Core Network Gateway node includes steps of:
comparing at the Core Network Gateway node the encapsulated packet data received on the at least one assigned LSP in the first service area and the encapsulated packet data received on the at least one assigned LSP in the second service area;
detecting at the Core Network Gateway node a packet data loss of encapsulated packet data on the at least one assigned LSP in the first service area;
switching at the Core Network Gateway node the encapsulated packet data sent from the MT on the at least one assigned LSP in the first service area to at least one assigned LSP in the second service area; and
canceling the at least one assigned LSP in the first service area.

5. The method of claim 1, wherein the method further comprises a step of receiving at the Core Network Gateway node a RA complete message from the MT for indicating that the handoff has been completed.

6. The method of claim 4, wherein the step of detecting at the Core Network Gateway node the packet data loss of encapsulated packet data on the at least one assigned LSP in the first service area further includes the steps of
detecting the traffic level priority of encapsulated packet data sent on the at least one assigned LSP in the first service area:
if the traffic level is not a high priority level traffic:
the Core Network Gateway node performs dynamic break before make mode of operation; and
if the traffic level is a high priority level traffic:
the Core Network Gateway node performs a static make before break mode of operation.

7. The method of claim 1, wherein the step of assigning at the Core Network Gateway node the at least one LSP for the MT in the second service area includes the steps of:
determining at the Core Network Gateway node that the encapsulated packet data are sent from the Corresponding node to the MT on the LSP in the first service area;
duplicating at the Core Network Gateway node the encapsulated packet data that are sent from the Corresponding node to the MT;
sending the duplicated encapsulated packet data from the Core Network Gateway node to the MT, wherein the duplicated encapsulated packet data are sent on the at least one assigned LSP in the second service area.

8. The method of claim 7, wherein the step of sending at the Gateway node includes steps of:
comparing at the Core Network Gateway node the encapsulated packet data received on the at least one assigned LSP in the first service area and the encapsulated packet data received on the at least one assigned LSP in the second service area;
detecting at the Core Network Gateway node a packet data loss of encapsulated packet data on the at least one assigned LSP in the first service area;
switching the encapsulated packet data from the at least one assigned LSP in the first service area to at least one assigned LSP in the second service area; and
canceling the at least one assigned LSP in the first service area.

9. The method of claim 7, wherein the method further comprises a step of receiving at the Core Network Gateway node a RA complete message from the MT for indicating that the handoff has been completed.

10. The method of claim 8, wherein the step of detecting at the Core Network Gateway node the packet data loss of encapsulated packet data on the at least one assigned LSP in the first service area further includes the steps of:
detecting the traffic level priority of encapsulated packet data sent on the at least one assigned LSP in the first service area:
if the traffic level is not a high priority level traffic:
the Core Network Gateway node performs dynamic break before make mode of operation; and
if the traffic level Is a high priority level traffic:
the Core Network Gateway node performs a static make before break mode of operation.

11. A method for performing a handoff operation for a Mobile Terminal (MT), wherein the MT is connected to a Core Network Gateway node through at least one assigned Label Switching Path (LSP) in a first service area of a packet data network, the method comprising the steps of:
receiving at the Core Network Gateway node a routing area (RA) request from the MT, the RA request indicating that the MT is handing off from a first Access server in the first service area to a second Access server in a second service area of the packet data network;
assigning at the Core Network Gateway node at least one LSP for the MT in the second service area;
duplicating at the Core Network Gateway node the encapsulated packet data sent from a Corresponding node to the MT; and
sending from the Core Network Gateway node to the MT, the duplicated encapsulated packet data, wherein the duplicated encapsulated packet data are sent on the at least one assigned LSP in the second service area.

12. The method of claim 11, wherein the step of sending at the Core Network Gateway node includes steps of:
comparing at the Core Network Gateway node the encapsulated packet data received on the at least one assigned LSP in the first service area and the encapsulated packet data received on the at least one assigned LSP in the second service area;
detecting at the Core Network Gateway node a packet data loss of encapsulated packet data on the at least one assigned LSP in the first service area;
switching the encapsulated packet data from the at least one assigned LSP in the first service area; and
canceling the at least one assigned LSP in the first service area.

13. The method of claim 11, wherein the step of sending a path setup request from the Core Network Gateway node to a TE-CMS for assigning at the Core Network Gateway node at least one LSP for the MT in the second service area is executed Prior to the step of assigning at the Core Network Gateway node the at least one LSP for the MT in the second service area.

14. The method of claim 12, wherein the step of detecting at the Core Network Gateway node the packet data loss of encapsulated packet data on the at least one assigned LSP in the first service area further includes the steps of:
detecting the traffic level priority of encapsulated packet data sent on the at least one assigned LSP in the first service area:
if the traffic level is not a high priority level traffic:
the Core Network Gateway node performs dynamic break before make mode of operation; and
if the traffic level is a high priority level traffic:
the Gateway node performs a static make before break mode of operation.

15. The method of claim 11, wherein the method further includes a step of receiving from the MT a RA complete message for indicating that the handoff has been completed.

16. The method of claim 11, wherein the method further includes the steps of determining at the Core Network Gateway node that the encapsulated packet data are sent from the MT a Corresponding node;
combining at the Core Network Gateway node, the at least one assigned LSP in the first service area and the at least one assigned LSP in the first service area; and
sending the combined encapsulated packet data from the Core Network Gateway node to the Corresponding node.

17. The method of claim 16, wherein the step of combining includes a step of eliminating redundant encapsulated packet data received at the Core Network Gateway node on the at least one assigned LSP in the first service area and to the at least one assigned LSP in the second service area.

18. The method of claim 16, wherein the step of sending at the Core Network Gateway node includes steps of:
comparing at the Core Network Gateway node the encapsulated packet data received on the at least one assigned LSP in the first service area and the encapsulated packet data received on the at least one assigned LSP in the second service area;
detecting at the Core Network Gateway node a packet data loss of encapsulated packet data on the at least one assigned LSP in the first service area;
switching at the Core network Gateway node the encapsulated packet data from the at least one assigned LSP in the first service area to at least one assigned LSP in the second service area; and
canceling the at least one assigned LSP in the first service area.

19. The method of claim 16, wherein the step of switching further includes a step of receiving at the Core Network Gateway node a RA complete message from the MT for indicating that the handoff has been completed.

20. The method of claim 18, wherein the step of detecting at the Core Network Gateway node the packet data loss of encapsulated packet data on the at least one assigned LSP in the first service area further includes the steps of:
detecting the traffic level priority of encapsulated packet data sent on the at least one assigned LSP in the first service area:
if the traffic level is not a high priority level traffic:
the Core Network Gateway node performs dynamic break before make mode of operation; and
if the traffic level is a high priority level traffic:
the Core Network Gateway node performs a static make before break mode of operation.

21. A Core Network Gateway node for routing encapsulated packet data to a MT during a handoff operation, the Core Network Gateway node comprising:
a service logic for receiving at the Core Network Gateway node a Routing Area (RA) request from the MT, the RA request indicating that the MT is handing off from a first service area to a second service area of a Core Network, assigning at least one LSP for the MT in the second area detecting at the Core Network Gateway node that the traffic direction of encapsulated packet data sent on the at least one assigned LSP in the first service area, sending from the Core Network Gateway node to the MT the duplicated encapsulated packet data the packet data are sent on the at least one assigned LSP in the second service area, sending the combined encapsulated packet data from the Core Network Gateway node to a Corresponding node;
a duplicator for duplicating at the Core Network Gateway node the encapsulated packet data sent from a Corresponding node to the MT;
a combiner for combining at the Gateway node, encapsulated packet data sent on at least one assigned LSP in the second service area and at least one assigned LSP in the first service area; and
a switching element for switching the encapsulated packet data from the at least one assigned LSP in the first service for the at least one assigned LSP in the second service area.

22. The Core Network Gateway node of claim 21, wherein the service logic further compares the encapsulated packet data received on the at least one assigned LSP in the first service area and the encapsulated packet data received on the at least one assigned LSP in the second service area, detects a packet data loss of encapsulated packet data on the at least one assigned LSP in the first service area and sends a path setup request to a TE-CMS for assigning at the Core Network Gateway node at least one LSP for the MT in the second service area.

23. The Gateway node of claim 22, wherein the service logic further detects the traffic level priority of encapsulated packet data sent on the at least one assigned LSP in the first service area:
if the traffic level is not a high priority level traffic:
the service performs dynamic break before make mode of operation; and
if the traffic level is a high priority level traffic:
the service logic performs a static make before break mode of operation.

24. The Core Network Gateway node of claim 21, wherein the service logic further receives from the MT a Routing Area complete message for indicating that the handoff has been completed.

25. The Core Network Gateway node of claim 21, wherein the combiner further eliminates redundant encapsulated packet data received at the Core Network Gateway node on the at least one assigned LSP in the first service area and on the at least one assigned LSP in the second service area.
